(19) United States
(12) Patent Application Publication
(10) Pub. No.: US 2014/0306873 A1
(43) Pub. Date: Oct. 16, 2014

(54) BACKLIGHT APPARATUS AND DISPLAY APPARATUS

(71) Applicant: FUNAI ELECTRIC CO., LTD., Osaka (JP)

(72) Inventors: Hiroshi YAMASHITA, Osaka (JP); Tatsuya KITA, Osaka (JP)

(73) Assignee: FUNAI ELECTRIC CO., LTD., Osaka (JP)

(21) Appl. No.: 14/242,963

(22) Filed: Apr. 2, 2014

(30) Foreign Application Priority Data
Apr. 11, 2013 (JP) 2013-083388

(51) Int. Cl. G09G 3/34

(52) U.S. Cl. CPC G09G 3/3406
USPC 345/102

(57) ABSTRACT

In a backlight apparatus according to an aspect, a plurality of backlight drivers are connected in cascade arrangement, and when a drive signal is provided to the backlight driver corresponding to one of a backlight group positioned uppermost and a backlight group positioned lowermost in a sub scanning direction Y, each of the backlight drivers delays the drive signal by a predetermined period and outputs the delayed drive signal in order of the arrangement of the backlight drivers.

### CROSS REFERENCE TO RELATED APPLICATION

The present application is based on and claims priority of Japanese Patent Application No. 2013-083388 filed on Apr. 11, 2013. The entire disclosure of the above-identified application, including the specification, drawings and claims is incorporated herein by reference in its entirety.

### FIELD

The present invention relates to a backlight apparatus and a display apparatus including the backlight apparatus.

### BACKGROUND

In recent years, liquid crystal display (LCD) apparatuses (hereinafter referred to as display apparatuses) are becoming popular as display apparatuses such as televisions and monitors, replacing the conventional cathode-ray tubes.

These types of display apparatuses display an image on an LCD screen by changing orientations of liquid crystal molecules in the LCD screen and causing a backlight to emit light behind the LCD screen.

In the meantime, these types of display apparatuses turn on or off the backlight behind the LCD screen by pulse width modulation (PWM) control, and a duty signal is provided to the backlight in the PWM control. For this reason, since the backlight is turned off in the off-duty period, all of the backlights are turned on or off in the same period. Various techniques for preventing simultaneously turning on or off light have been developed, such as Patent Literature (PTL) 1 below. PTL 1 discloses that the constant voltage output circuit prevents a constant current from simultaneously flowing through each of the LEDs, thereby trying to prevent motion blur.

### CITATION LIST

### Patent Literature

[PTL 1] Japanese Unexamined Patent Application Publication No. 2009-188135

### SUMMARY

### Technical Problem

However, such display apparatuses are likely to require a complicated configuration and involve complicated processes. In view of the above, the present invention has been conceived to solve the above-described problem, and an object of the present invention is to provide a backlight apparatus capable of minimizing motion blur with a simple configuration and processes, and a display apparatus provided with the backlight apparatus.

### Solution to Problem

In order to achieve the above-described object, the backlight apparatus according to an aspect of the present invention includes: a plurality of backlight groups arranged in a sub scanning direction of a liquid crystal display (LCD) screen, each of the backlight groups including a plurality of backlights arranged in a main scanning direction of the LCD screen, each of the backlights emitting light toward a back surface of the LCD screen; a plurality of backlight drivers each connected to a corresponding one of the backlight groups for driving the corresponding backlight group; and a signal outputting unit which is connected to the backlight driver connected to one of the backlight group positioned uppermost and the backlight group positioned lowermost in the sub scanning direction, among the plurality of backlight groups, and is configured to output a drive signal for driving the backlight driver for a set period which is a previously set period, wherein the plurality of backlight drivers are connected in cascade arrangement, and when the drive signal is provided to the backlight driver corresponding to the one of the backlight group positioned uppermost and the backlight group positioned lowermost in the sub scanning direction, each of the backlight drivers delays the drive signal by a predetermined period and outputs the delayed drive signal in order of the arrangement of the backlight drivers.

According to this configuration, the backlight drivers each corresponding to different one of the backlight groups arranged in the sub scanning direction of the LCD screen are connected in cascade arrangement, and when a drive signal is provided to a backlight driver corresponding to any one of the backlight group positioned uppermost and the backlight group positioned lowermost in the sub scanning direction of the LCD screen, the drive signal is outputted with a delay of a predetermined period, from the backlight drivers starting from a backlight driver which has received the drive signal first and in order of the arrangement of the backlight drivers.

In sum, when receiving a drive signal from an adjacent backlight driver disposed at a preceding stage, each of the backlight drivers outputs the drive signal to a backlight driver which is adjacent at an opposite side to the adjacent backlight driver and disposed at a subsequent stage, with a delay of a predetermined period. Since the LEDs each can be turned on in order of the arrangement in the sub scanning direction only by such a process by the backlight drivers, it is possible to minimize motion blur with a simple configuration and processes.

For example, each of the backlight drivers may change a phase of the drive signal by outputting the drive signal with a delay. With this, it is possible to easily change the phase of a drive signal just by delaying output of the drive signal, and thus the delay circuit can be configured at low costs, as a result making it possible to prevent motion blur at low costs.

In addition, each of the backlight drivers may drive the corresponding backlight group in response to an application of a divided voltage obtained from voltage-dividing resistances, and may delay the drive signal to satisfy the Expression (1) below.

T1/T2=R11/R12 Expression (1)

It is to be noted that T1 denotes a delay time of the drive signal, T2 denotes a time period obtained by subtracting the delay time from a period of one cycle of the drive signal, and R11 and R12 denote the voltage-dividing resistances for a corresponding one of the backlight drivers.

According to this configuration, the voltage-dividing resistances R11 and R12 are provided such that the ratio between the delay time T1 of a drive signal and the time T2 obtained by subtracting the delay time T1 from a period of one cycle of the drive signal is equivalent to the ratio between the voltage-dividing resistance R11 and the voltage-dividing resistance R12, and thus it is possible to set the delay time with a simple technique.

Or, each of the backlight drivers may drive the corresponding backlight group in response to an application of a divided voltage obtained from voltage-dividing resistances, may include a counter for counting a period of one cycle of the provided drive signal, and a voltage application unit configured to apply a voltage to the voltage-dividing resistances, and may output the drive signal with a delay to satisfy the Expression (2) below.

T1=C(Tp)×(V11/V1) Expression (2)

It is to be noted that T1 denotes a delay time of the drive signal, C(Tp) denotes the period of one cycle of the drive signal, V11 denotes the divided voltage divided by the voltage-dividing resistances, and V1 denotes a voltage value of the voltage application unit.

According to this configuration, a counter for counting a period of one cycle of a drive signal is provided, and a delay time is a multiplication value obtained by multiplying a count value of the counter and a value resulting from dividing the divided voltage V11 by the voltage value V1 of the voltage application unit, making it possible to set a delay time with a simple technique using a product of the count value and the multiplication value.

In addition, each of the backlight drivers may drive the corresponding backlight group such that an entire light-out state in which all of the backlight groups are turned off appears several times in one frame period in which one frame is displayed on the LCD screen.

According to this configuration, it is possible to minimize flicker.

In addition, a display apparatus according another aspect of the present invention includes the above-described backlight apparatus, and a liquid crystal display (LCD) screen which receives an image signal representing an image and displays the image, the LCD screen having a back surface to which light is emitted by the backlight apparatus.

According to this configuration, since the backlight apparatus described above is included, it is possible to provide a display apparatus which produces the above-described advantageous effects.

### Advantageous Effects

According to the present invention, it is possible to minimize motion blur on the display screen, with a simple configuration and processes.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is a perspective view of a display apparatus provided with a backlight apparatus according to an embodiment of the present invention.

FIG. 2 is a functional block diagram of the display apparatus provided with the backlight apparatus according to the embodiment of the present invention.

FIG. 3 is a diagram which schematically illustrates LED groups (backlight groups) arranged on an LCD screen.

FIG. 4 is a diagram which schematically illustrates an example of LED drivers.

FIG. 5 is a timing chart which illustrates an example of an operation of the display apparatus.

FIG. 6 is a diagram which illustrates an example of a specific configuration of the LED driver.

FIG. 7 is a timing chart for describing settings of a delay time by the backlight apparatus.

FIG. 8 is a diagram which schematically illustrates a configuration of a display apparatus according to a comparative example.

FIG. 9 is a diagram which schematically illustrates a configuration of a display apparatus according to another comparative example.

FIG. 10 is a diagram which schematically illustrates a configuration of a display apparatus according to yet another comparative example.

FIG. 11 is a timing chart which illustrates an operation of the display apparatus according to a comparative example.

### DESCRIPTION OF EMBODIMENT

(Underlying Knowledge Forming Basis of the Present Disclosure)

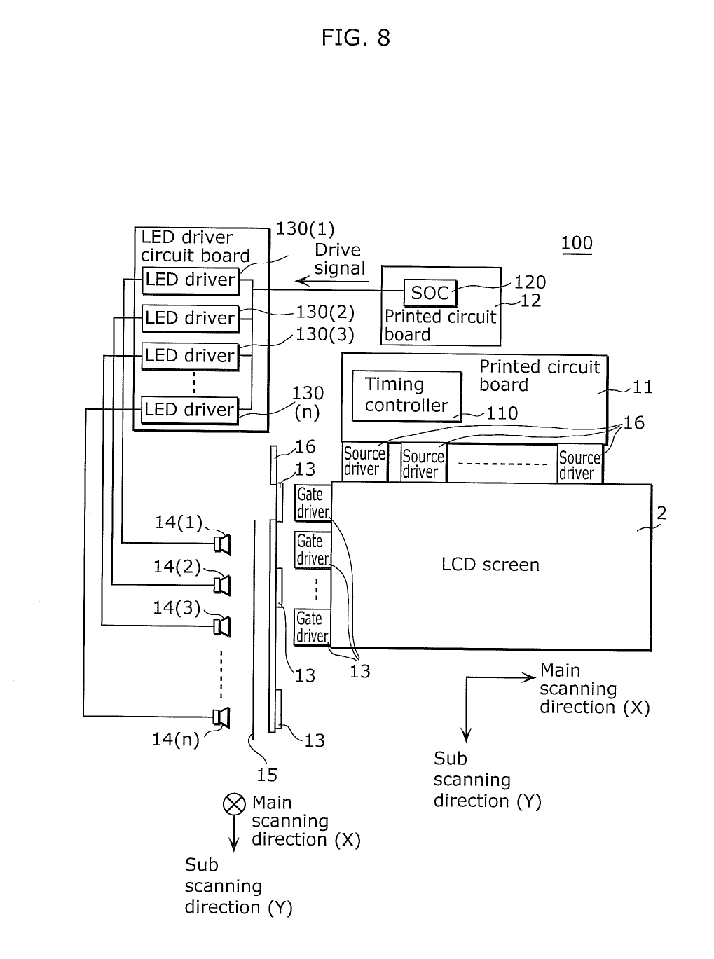

In relation to the conventional display apparatus disclosed in the Background section, the inventors have found that the configuration and processes are likely to be complicated as described above. The following describes the reason why the configuration and processes are complicated, with reference to display apparatuses according to comparative examples illustrated in FIG. 8 through FIG. 10.

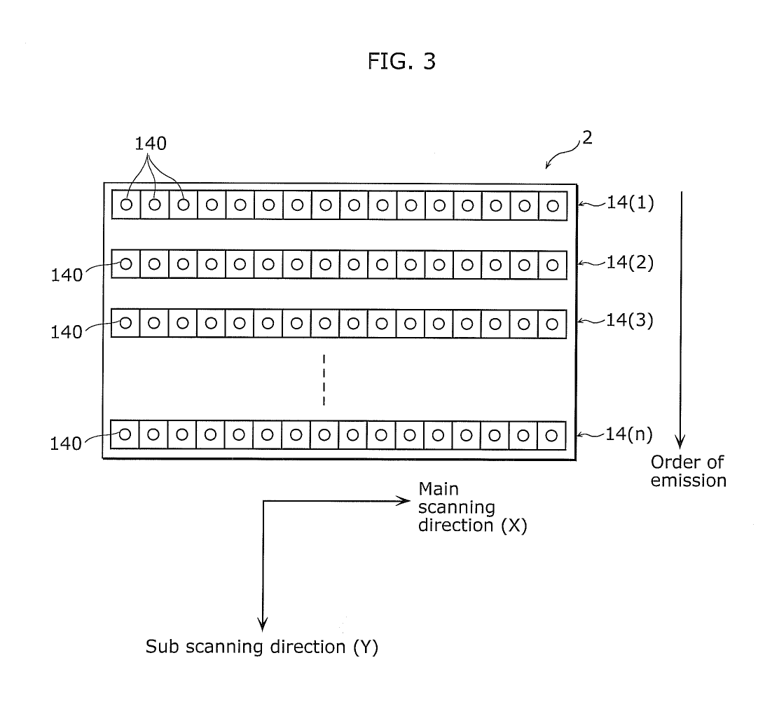

FIG. 8 is a diagram which schematically illustrates a configuration of a display apparatus according to a comparative example. It should be noted that FIG. 8 and FIG. 3 described later share the same reference signs for the same structural elements, and detailed description for each of the structural elements will be given later.

In a display apparatus 100 of the comparative example, a system-on-a-chip (SOC) 120 outputs, as a drive signal, an asynchronous duty signal that is a signal not in synchronization with an image signal, to each of the LED drivers 130(1) to 130(n). Meanwhile, a plurality of source drivers 16 and a plurality of gate drivers 13 are arranged on an LCD screen 2. The source drivers 16 and the gate drivers 13 are respectively connected to sources and gates of field effect transistors (FETs) arranged in the LCD screen 2, and provided as many as the number of the FETs.

Further, the LCD screen 2 is provided with a timing controller 110 mounted on a printed circuit board 11. The LED drivers 130(1) to 130(n) are provided with LED groups 14(1) to 14(n), respectively, which shine the back of the LCD screen 2. Each of the LED groups 14(1) to 14(n) includes a plurality of LEDs in a main scanning direction (hereinafter referred to as an X direction) of the LCD screen 2. These LED groups 14(1) to 14(n) are arranged in a sub scanning direction (hereinafter referred to as a Y direction) of the LCD screen 2, and emit light toward a back surface of the entire LCD screen 2. Light emitted from each of the LED groups 14(1) to 14(n) is diffused by a diffuser panel 15.

According to this configuration, a plurality of LED drivers 130 are connected in parallel, and the SOC 120 is connected to a common line bridging the respective LED drivers 130. For this reason, the SOC 120 provides drive signals in phase to each of the LED drivers 130(1) to 130(n). With such a configuration, the LEDs are simultaneously turned on or off, and thus blur occurs in moving images. In order to minimize motion blur, it is desired to turn on or off light according to the latest display.

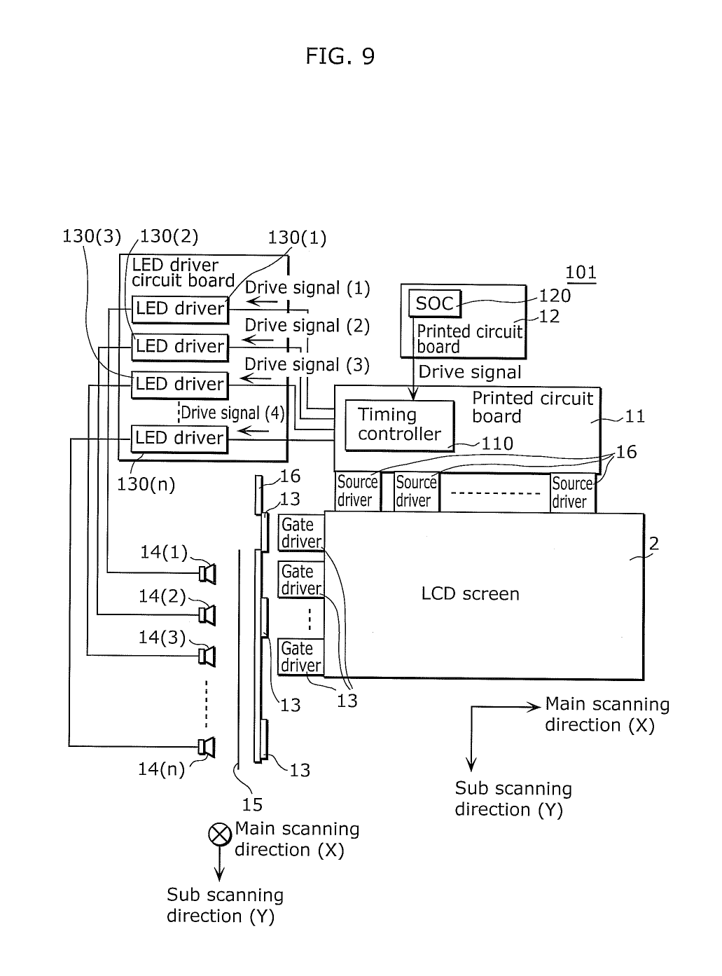

In view of the above, a display apparatus according to another comparative example illustrated in FIG. 9 has been developed. FIG. 9 is a diagram which schematically illustrates a configuration of the display apparatus according to the comparative example. It should be noted that FIG. 9 and FIG. 8 share the same reference signs for the same structural elements and description for them will be omitted for sake of simplicity.

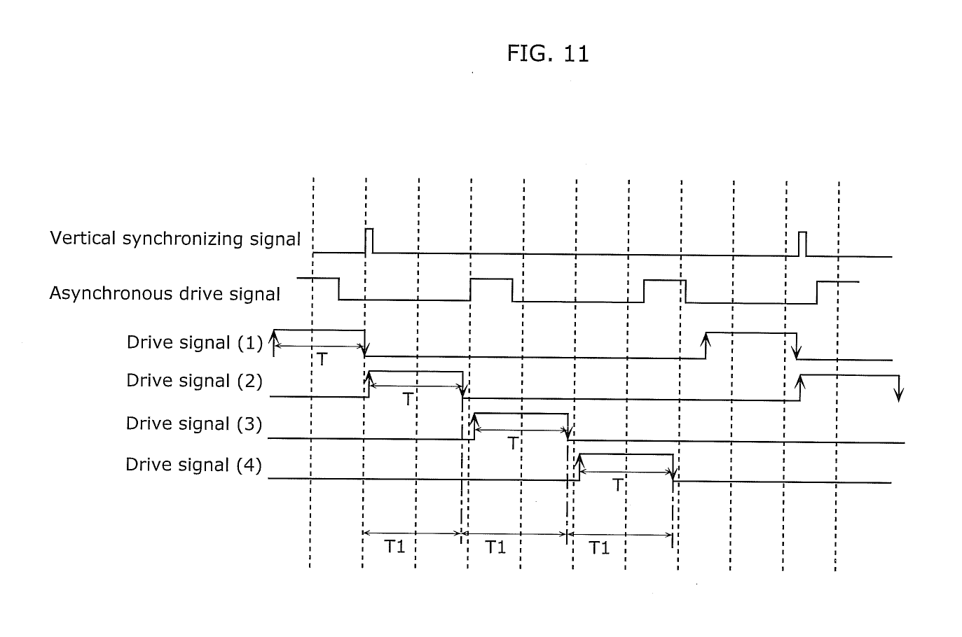

With a display apparatus 101, the timing controller 110 receives an asynchronous duty signal provided from the SOC 120, processes the received duty signal to cause a phase difference in order of the arrangement of the LED driver 130(1) to the LED driver 130(n), and outputs drive signals (1) to (n) sequentially to the respective LED drivers 130(1) to 130(n). With this, waveforms illustrated in FIG. 11 can be obtained.

FIG. 11 is a timing chart which illustrates an operation of the display apparatus 101 of a comparative example illustrated in FIG. 9. It should be noted that four drive signals (1) to (4) are illustrated in FIG. 11 as examples of drive signals, for sake of simplicity.

In FIG. 11, a vertical synchronizing signal is a signal for notifying start of one frame, and the asynchronous drive signal is outputted regardless of the vertical synchronizing signal. The drive signals (1) to (4) are signals obtained by processing the asynchronous drive signal by the timing controller 110, and outputted at intervals of equivalent delay time (T1) in order of the LED driver 130(1) to 130(4). It should be noted that T denotes an on-duty period of a drive signal.

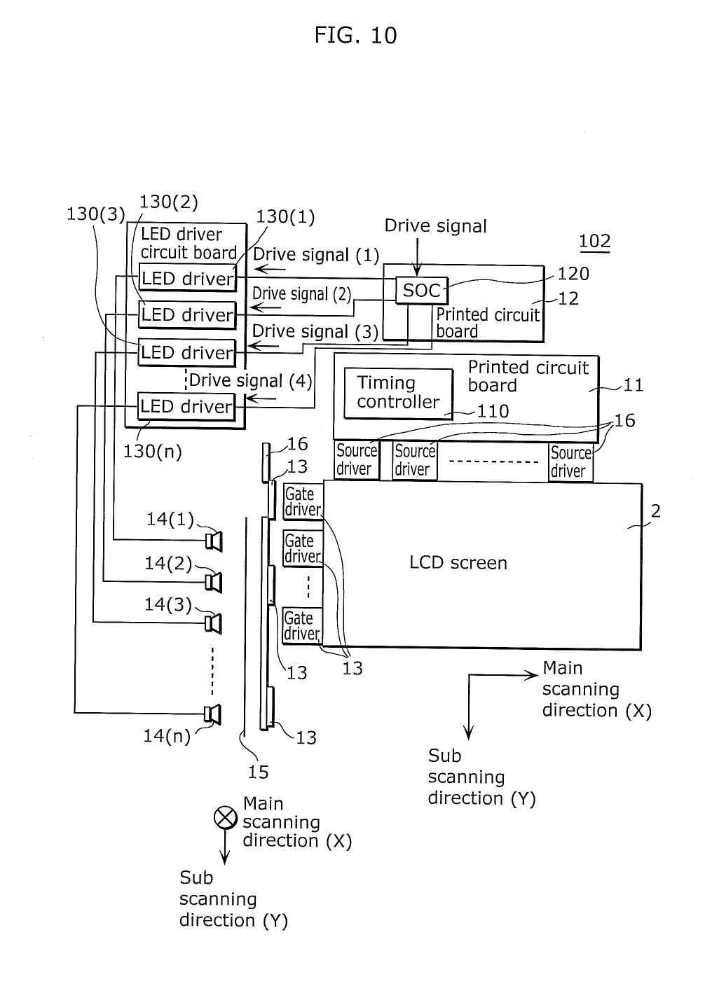

In addition, the waveforms illustrated in FIG. 11 can also be obtained by the display apparatus illustrated in FIG. 10. FIG. 10 is a diagram which schematically illustrates a configuration of the display apparatus according to yet another comparative example. It should be noted that FIG. 10 and FIG. 8 share the same reference signs for the same structural elements and description for them will be omitted for sake of simplicity.

With the display apparatus 102, the SOC 120 processes an asynchronous duty signal, so that drive signals (1) to (4) are provided to the respective LED drivers at intervals of the delay time T1 in order of the LED driver 130(1) to LED driver 130(n).

However, the display apparatuses 100 to 102 according to the comparative examples described above pose problems below.

The display apparatus 100 illustrated in FIG. 8 is not capable of completely minimizing motion blur.

Furthermore, the display apparatus 101 illustrated in FIG. 9 causes a phase difference between drive signals to the respective LED drivers 130(1) to 130(n), and thus is capable of further minimizing motion blur than the display apparatus 100 illustrated in FIG. 8. However, a line is required for connecting the timing controller 110 and each of the LED drivers 130(1) to 130(n). The number of lines increases as the number of the LED groups 14(1) to 14(n) increases, leading to higher costs.

In addition, with the display apparatus 102 illustrated in FIG. 10, the number of lines for connecting the SOC and each of the LED drivers increases as the number of the LED groups 14(1) to 14(n) increases, and thus it leads to higher costs.

In addition, in the case where the number of lines connecting the SOC 120 or the timing controller 110 to each of the LED groups 14(1) to 14(n) increases, it is necessary to accordingly change the configuration of the SOC 120 or the timing controller 110.

As described above, the display apparatuses 100 to 102 of the comparative examples each pose the problem that it is difficult to minimize motion blur with a simple configuration and processes.

In order to solve the above-described problems, the backlight apparatus according to an aspect of the present invention includes backlight drivers each corresponding to a different one of backlight groups disposed in cascade arrangement in the sub scanning direction of the LCD screen, and when a drive signal is inputted to a backlight driver corresponding to any one of the backlight group positioned uppermost and the backlight group positioned lowermost in the sub scanning direction, each of the backlight drivers outputs a drive signal with a delay of a predetermined period in order of the arrangement of the backlight drivers.

In sum, when receiving a drive signal from an adjacent LED driver disposed at a preceding stage, each of the LED drivers outputs the drive signal to another adjacent LED driver disposed at a subsequent stage with a delay of a predetermined period. Since the LEDs each can be turned on in order of the arrangement in the sub scanning direction only by such a process by the LED drivers, the backlight apparatus according to an aspect of the present invention is capable of minimizing motion blur with a simple configuration and processes.

### Embodiment

Hereinafter, certain exemplary embodiments are described in greater detail with reference to the accompanying Drawings. It should be noted that the embodiment described below shows a specific preferred example of the present invention. The numerical values, structural elements, the arrangement and connection of the structural elements etc. shown in the following exemplary embodiment are mere examples, and therefore do not limit the present invention. The scope of which is defined in the appended Claims. As such, among the structural elements in the following exemplary embodiment, structural elements not recited in any one of the independent claims are described as structural elements of a preferable embodiment, and are not absolutely necessary to overcome the problem according to the present invention.

[Exterior Configuration of the Display Apparatus]

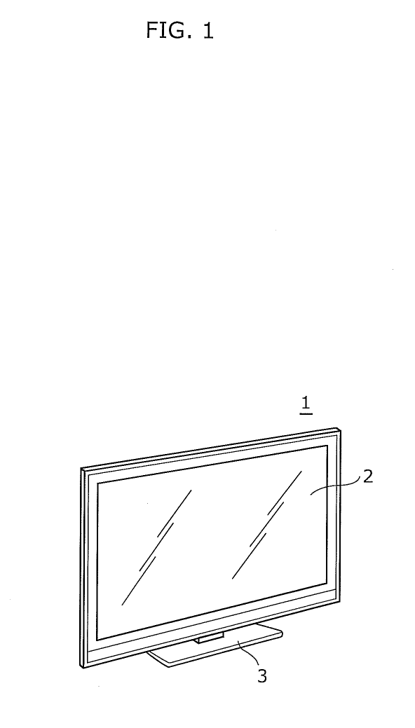

FIG. 1 is a perspective view of a display apparatus provided with a backlight apparatus according to an embodiment of the present invention. A display apparatus 1 is, as it is called, a liquid crystal display. An LCD screen 2 is provided on a front surface of the display apparatus 1. The display apparatus 1 includes a leg portion 3 for placing the display apparatus 1 on a flat surface by placing the leg portion 3 on a desk, for example.

[Functional Block Configuration of the Display Apparatus]

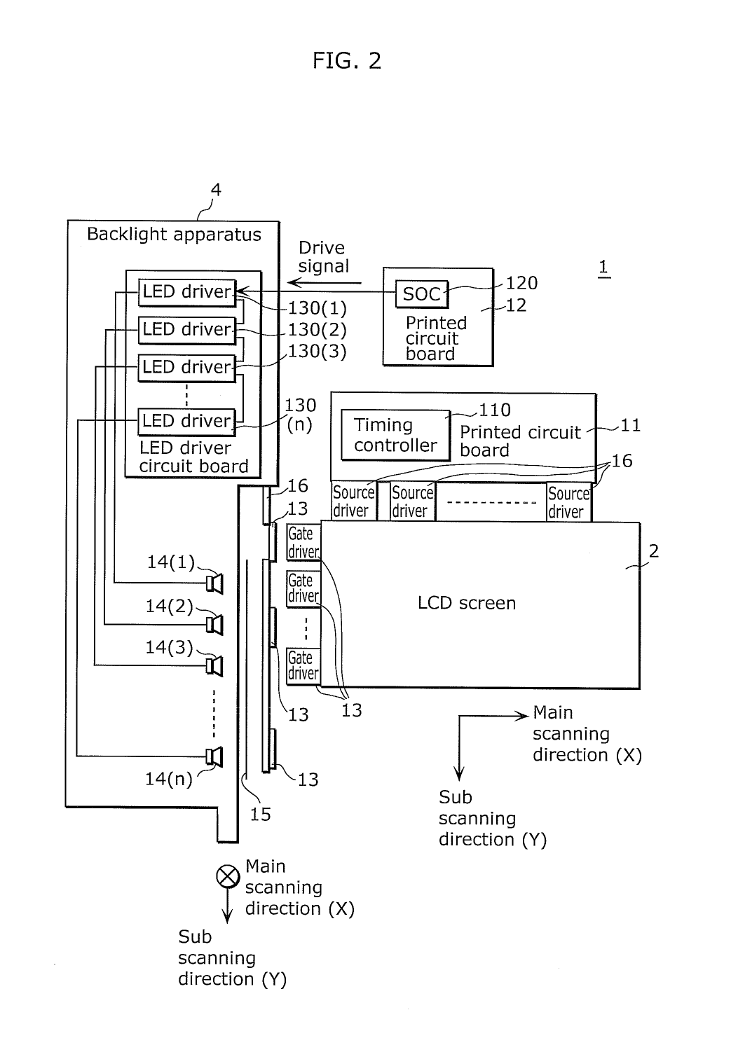

FIG. 2 is a functional block diagram of the display apparatus provided with a backlight apparatus according to an embodiment of the present invention. It is to be noted that, in FIG. 2, a backlight apparatus 4 is viewed in the main scanning direction (hereinafter referred to as an X direction) of the LCD screen 2, and the LCD screen 2 is viewed from the front.

The display apparatus 1 includes: the backlight apparatus 4 according to an embodiment of the present invention; the LCD screen 2; a printed circuit board 11 on which a timing controller 110 is mounted; a plurality of gate drivers 13; a plurality of source drivers 16; and a printed circuit board 12 on which an SOC (a signal processing unit) 120 is mounted.

A plurality of n-channel FETs for changing the orientations of liquid crystal molecules are arranged on the back surface of the LCD screen 2 in the X direction and a sub scanning direction (hereinafter referred to as a Y direction) of the LCD screen 2. In addition, a plurality of gate drivers 13 and a plurality of source drivers 16 are arranged on the back surface of the LCD screen 2. The gate drivers 13 and the source drivers 16 are respectively connected to gates and sources of the FETs arranged in the LCD screen 2, and provided as many as the number of the FETs.

The gate drivers 13 and the source drivers 16 respectively supply a gate voltage and a source voltage for each of the FETs. Each of the FETs is turned on or off according to the gate voltage, and the source voltage at the time when the FET is turned on is provided to a liquid crystal element including liquid crystal molecules.

It should be noted that, although the FETs are employed in FIG. 2 for changing the orientations of the liquid crystal molecules, the present invention is not limited to this, and an element having a switching function such as a bipolar transistor and so on may be employed.

The backlight apparatus 4 includes the LED drivers 130(1) to 130(n), and the LED groups 14(1) to 14(n).

[Outline Configuration of the LED Groups]

FIG. 3 is a diagram schematically illustrates the LED groups (backlight groups) 14(1) to 14(n) arranged on the LCD screen 2.

Each of the LED groups 14(1) to 14(n) includes the LEDs 140 arranged in the X direction of the LCD screen 2. In addition, the LED groups 14(1) to 14(n) are arranged in order of the LED groups 14(1) to 14(n) in the Y direction of the LCD screen 2. Each of the LED groups 14(1) to 14(n) emits light to the back surface of the LCD screen 2 in order of the LED groups 14(1) to 14(n). Light emitted from each of the LED groups 14(1) to 14(n) is diffused by the diffuser panel 15 described above.

[Outline Configuration of the LED Drivers]

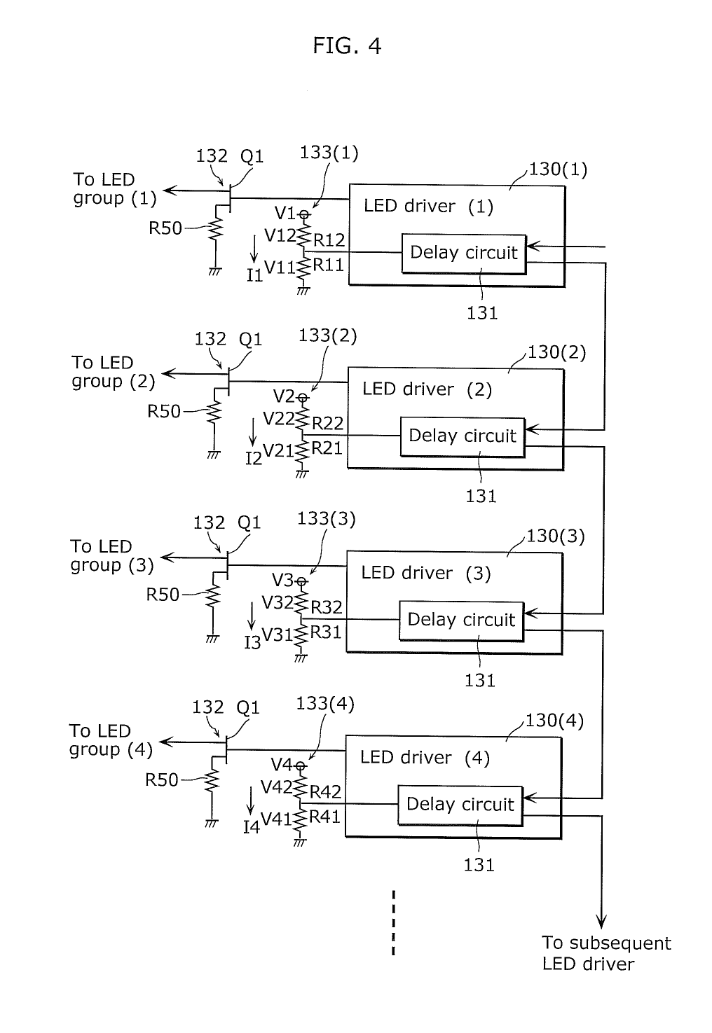

FIG. 4 is a diagram schematically illustrating an example of the LED drivers 130(1) to 130(n). It should be noted that, although four LED drivers (backlight drivers) 130(1) to 130(4) are illustrated as examples in FIG. 4 for sake of simplicity, the present invention is not limited to this, and it is sufficient that a plurality of LED drivers are disposed. In addition, the LED drivers 130(1) to 130(n−1) each have the same configuration. However, since an LED driver at the subsequent stage is not present for the LED driver 130(n) disposed at the lowermost position in the Y direction, it is not necessary for the LED driver 130(n) to delay a provided drive signal. For this reason, it is not necessary for the LED driver 130(n) to include the delay circuit 131. The following describes the LED drivers 130(1) to the LED drivers 130(4) in detail.

The LED drivers 130(1) to 130(4) are connected in the cascade arrangement.

Switching circuits 132, each of which is for outputting a drive signal to a corresponding one of the LED groups, are disposed in one-to-one relationship with the LED drivers 130(1) to 130(4). In the switching circuit 132, a switching element Q1 formed of an n-channel FET, for example, is provided, and a resistance 50 is connected between a source and a ground of the switching element. It is to be noted that it is possible to employ an element having the switching function, such as the bipolar transistor and so on, as the switching element.

In addition, each of the LED drivers 130(1) to 130(4) is connected to the gate of a corresponding one of the switching elements Q1, and a drive signal received by each of the LED drivers 130(1) to 130(4) is provided to the gate. With this, the switching circuit 132 is turned on, and an on-duty signal is outputted to each of the LED groups as the drive signal.

In addition, each of the LED drivers 130(1) to 130(4) includes a delay circuit 131. Each of the delay circuits 131 is formed of, for example, a phase shift circuit. Each of the delay circuits 131 receives a drive signal and delays the drive signal by a predetermined delay time, thereby changing the phase of the signal (performing phase shift).

The delay circuit 131 delays a drive signal in response to an application of a voltage generated by a corresponding one of constant-voltage circuits 133(1) to 133(4). The constant-voltage circuits 133(1) to 133(4) are disposed in one-to-one relationship with the LED drivers 130(1) to 130(4). For example, the constant-voltage circuit corresponding to the LED driver 130(1) is the constant-voltage circuit 133(1).

Each of the constant-voltage circuits 133(1) to 133(4) has a configuration below. The following describes the configuration of the constant-voltage circuit 133(1) corresponding to the LED driver 130(1), and since the other constant-voltage circuits 133(2) to (n−1) each have the same configuration as the configuration of the constant-voltage circuit 133(1), description for them will be omitted.

The constant-voltage circuit 133(1) has two voltage-dividing resistances, R11 and R12, which are connected in series between a power source V1 and the ground. The delay circuit 131 is supplied with a divided voltage generated between the voltage-dividing resistances R11 and R12 to delay a drive signal.

As described above, each of the LED drivers 130(1) to 130(4) includes the delay circuit 131, and the delay circuit 131 delays a drive signal using a voltage supplied by the corresponding one of the constant-voltage circuits 133(1) to 133(4), thereby outputting a delayed drive signal. The outputted drive signal which has been delayed as above is provided to the LED groups 14(1) to 14(n) via the switching circuit 132, thereby allowing the LED group (1) to LED group (4) to be turned on or off sequentially in the sub scanning direction.

The configuration of the LED drivers 130(1) to 130(4) will be described later in more detail.

[Operation of the Display Apparatus]

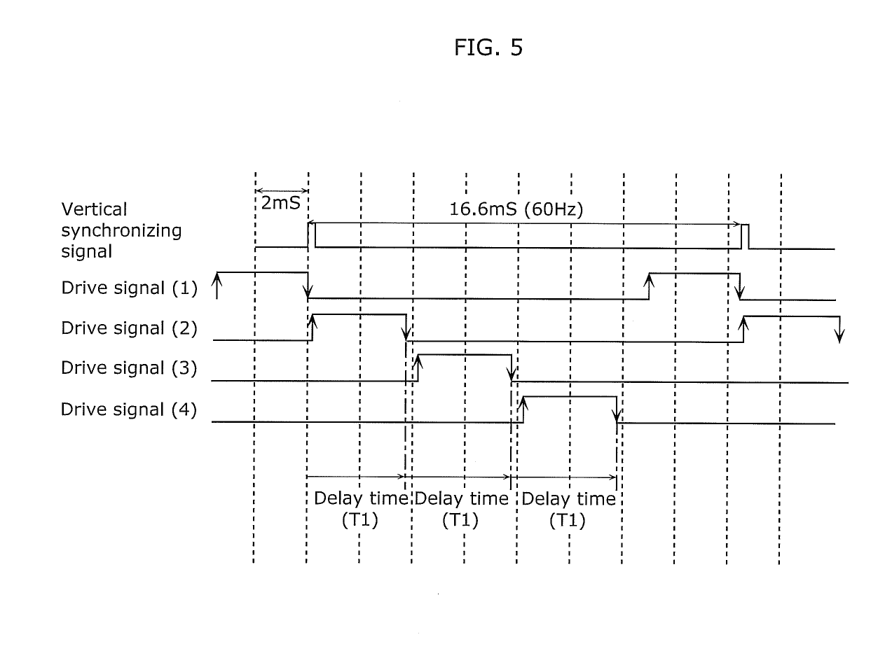

The following describes an example of the operation performed by the display apparatus 1 having the above-described configuration, with reference to FIG. 2 to FIG. 5. FIG. 5 is a timing chart which illustrates an example of the operation of the display apparatus 1.

In FIG. 2, the display apparatus 1 receives a video signal from a broadcast station, using a not-illustrated television tuner. Since the video signal includes a vertical synchronizing signal and a horizontal synchronizing signal, the display apparatus 1 synchronizes the video signal based on these signals, and displays an image represented by the video signal on the LCD screen.

In the LCD screen 2, the FETs disposed on the back surface are turned on or off to change the orientations of the liquid crystal molecules, thereby causing an image based on the video signal is displayed on the LCD screen 2.

At this time, the backlight apparatus 4 operates as described below. As illustrated in FIG. 5, the SOC 120 outputs, to the LED driver 130(1), a drive signal (1) of which the on-duty period is T, in synchronization with a falling edge of the vertical synchronizing signal. At this time, the switching element Q1 corresponding to the LED driver 130(1) is turned on and the LED group 14(1) emits light.

With this, the LED driver 130(1) outputs, to the LED driver 130(2) disposed at the subsequent stage, a drive signal (2) resulting from the delay processing performed on the drive signal by the delay circuit 131. The LED drivers 130(2) to 130(n−1) sequentially perform the above-described processes. Then, each of the LED groups is turned on in order of the LED groups 14(1) to 14(n). The operation is performed likewise subsequent to a passage of a predetermined time period after the LED groups are turned on in order of the LED groups 14(1) to 14(n).

[Specific Configuration of the LED Drivers]

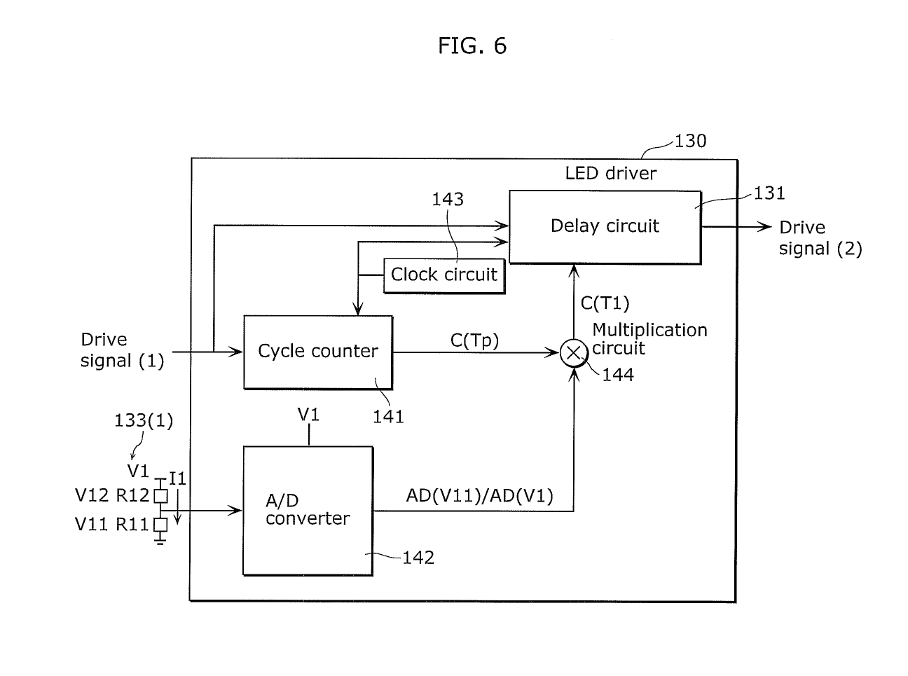

FIG. 6 is a diagram which illustrates an example of a specific configuration of the LED drivers 130(1) to 130(n). It should be noted that each of the LED drivers 130(1) to 130(n) may be referred to as the LED driver 130 in the following description when it is not necessary to specifically distinguish between them.

The LED driver 130 includes: the above-described delay circuit 131; a cycle counter 141; an A/D converter 142; a clock circuit 143; and a multiplication circuit 144.

The clock circuit 143 provides the delay circuit 131 and the cycle counter 141 with a clock signal.

The cycle counter 141 counts the number of clocks for a period of one cycle of the drive signal received by the LED driver 130, the drive signal (1) for example, and outputs the obtained value to the multiplication circuit 144, as the number of clocks C(Tp) representing a period of one cycle of the drive signal Tp.

The A/D converter 142 digitalizes a divided voltage V11 generated by the voltage-dividing resistances R11 and R12 based on a reference voltage V1. In sum, the A/D converter 142 outputs a digital value indicating (V11/V1).

The multiplication circuit 144 multiplies the number of clocks C(Tp) representing the period of one cycle of the drive signal and obtained by the cycle counter 141, by the digital value obtained by the A/D converter 142. Accordingly, the result of multiplication performed by the multiplication circuit 144 can be represented by Expression (3) below.

C(T1)=C(Tp)×(V11/V1) Expression (3)

In other words, the multiplication circuit 144 outputs, as a multiplication value that is a result of multiplication, the number of clocks which indicates a delay time in the delay circuit 131.

The delay circuit 131 delays the drive signal (1) by a delay time which is the multiplication value obtained by the multiplication circuit 144, and outputs the delayed drive signal as a drive signal (2). More specifically, the delay circuit 131 delays the drive signal (1) inputted into the LED driver 130 by the time period corresponding to the number of clocks provided by the multiplication circuit 144, and outputs the delayed drive signal (1) as the drive signal (2). Accordingly, the delay time in the delay circuit 131 can be represented by Expression (4) below.

T1=Tp×(V11/V1) Expression (4)

According to the configuration of the LED driver 130 as described above, a count value C(Tp) is obtained as a period of one cycle of a drive signal by the cycle counter 141. Then, the multiplication circuit 144 obtains a multiplication value of the count value C(Tp) as a period of one cycle of the drive signal and the value (V11/V1) obtained by the A/D converter 142, and provides the delay circuit 131 with the multiplication value as the number of clocks C(T1) representing the delay time T1. The delay circuit 131 delays the drive signal by the number of clocks representing the delay time T1 which has been provided, and outputs the delayed drive signal to the LED driver 130 disposed at the subsequent stage.

Accordingly, as indicated in Expression (4), the LED driver 130 is capable of delaying the provided drive signal by the delay time T1 according to the voltage value V1 of the constant-voltage circuit 133 and the divided voltage V11. In sum, the backlight apparatus 4 according to the embodiment is capable of setting the delay time T1 with a simple configuration and processes. The following describes the settings of a delay time in detail.

[Setting of Delay Time]

Expression (4) shows that the ratio between the delay time T1 and the period of one cycle Tp of a drive signal equals to the ratio between the divided voltage V11 and the power value V1 of the constant-voltage circuit 133. In other words, Expression (4) is expressed by Expression (5) below.

T1:Tp=V11:V1 Expression (5)

Accordingly,

T1/Tp=V11:V1 Expression (6)

Here, V11 is a value obtained by dividing V1 by the voltage-dividing resistances R11 and R12 of the constant-voltage circuit 133(1), and thus expressed by Expression (7) below.

V11=V1{R11/(R11+R12)} Expression (7)

Accordingly, Expression (8) below is obtained by substituting Expression (7) into the above-described Expression (6).

T1/Tp=R11/(R11+R12) Expression (8)

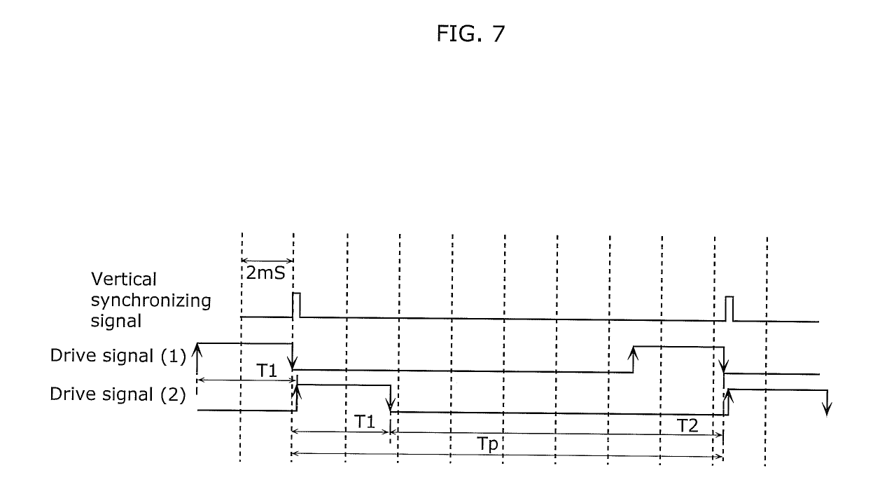

Here, as illustrated in FIG. 7, when T2 is a value obtained by subtracting the delay time T1 from a period of one cycle of the drive signal, the cycle Tp of the drive signal is represented by Expression (9) below. FIG. 7 is a timing chart for describing settings of the delay time T1 by the backlight apparatus 4.

Tp=T1+T2 Expression (9)

Expression (10) below holds by substituting this into Expression (8).

T1/(T1+T2)=R11/(R11+R12) Expression (10)

Expression (11) below finally holds by modifying Expression (10).

T1/T2=R11/R12 Expression (11)

As described above, since the ratio between the voltage-dividing resistances R11 and R12 equals to the ratio between the delay time T1 and the time T2 resulting from subtracting the delay time from a period of one cycle of the drive signal, the backlight apparatus 4 according to this embodiment is capable of easily setting the delay time T1 just by setting values of the voltage-dividing resistances R11 and R12. In sum, the backlight apparatus 4 according to the embodiment is capable of setting the delay time T1 with a simple configuration and processes.

In addition, each of the LED drivers 130(1) to 130(n) drives the corresponding one of LED groups 14(1) to 14(n) such that an entire light-out state in which all of the LED groups 14(1) to 14(n) are turned off appears several times in one frame period in which one frame is displayed on the LCD screen.

The following describes the reason.

It is difficult for human eyes to notice a change in the number of lighted LED groups, switching between lighted LED groups and non-lighted LED groups, and so on, in a light-up state where at least one of the LED groups 14(1) to 14(n) light up. On the other hand, it is easy to notice switching between the light-up state and an entire light-out state. This means that switching between the entire light-out state and the light-up state is likely to trigger flicker (flicker in the LCD screen 2).

In addition, It is easy for human eyes to notice blink of the LED groups 14(1) to 14(n) specifically when the entire light-out state appears only once during one frame period. Thus, in this case, flicker is likely to occur.

In view of the above, according to this embodiment, it is possible to minimize flicker by driving the plurality of LED groups 14(1) to 14(n) such that the entire light-out state appears several times during one frame period, as described above.

It should be noted that, as illustrated in FIG. 5 for example, one frame period refers to a period from a rise of a pulse to a rise of a next pulse of a vertical synchronizing signal included in a video signal. For example, when 60 frames are displayed in one second on the LCD screen 2, one frame period is approximately 16.6 ms.

More specifically, each of the LED drivers 130(1) to 130(n) delays a drive signal by a delay time T1 which causes the entire light-out state to appear several times in the one frame period and outputs the delayed signal. To be more specific, each of the LED drivers 130(1) to 130(n) delays a drive signal by a delay time T1 which satisfies Expression (12) below where one frame period is V.

V/n≦T1 Expression (12)

For example, in the case where the backlight apparatus 4 is provided with four LED drivers 130(1) to 130(4), each of the LED drivers 130(1) to 130(4) delays a drive signal by the delay time T1 which satisfies V/4≦T1. With this, the drive signal (1) to the drive signal (4) respectively provided from the LED drivers 130(1) to 130(4) to the LED group (1) to the LED group (4) has a state where all of the drive signal (1) to the drive signal (4) are low appears several times in the one frame period, as illustrated in FIG. 5. In sum, the entire light-out state in which all of the LED group (1) to the LED group (4) are turned off appears several times in the one frame period.

As described above, since the LED drivers 130(1) to 130(n) drive the plurality of LED groups 14(1) to 14(n) such that the entire light-out state appears several times in the one frame period, it is possible to minimize flicker.

It should be noted that the LED drivers 130(1) to 130(n) are not limited to those described above, and may delay a provided drive signal such that the entire light-out state appears only once in the frame period and output the delayed signal. The display apparatus 1 and the backlight apparatus 4 which includes the LED drivers 130(1) to 130(n) having the configuration as described above are also capable of minimizing motion blur with a simple configuration and processes.

### ADVANTAGEOUS EFFECTS

According to the present embodiment as described above, the plurality of LED drivers 130 are connected in cascade arrangement, and when a drive signal is provided to any one of the uppermost position and the lowermost position in the Y direction of the LCD screen 2, each of the LED drivers 130 outputs the drive signal with a delay of a predetermined period in order of the arrangement of the LED drivers 130 in the Y direction. With this, it is possible to minimize motion blur with a simple technique. In addition, unlike conventional techniques, it is not necessary to set frequency of the drive signal to several hundred Hz for controlling the LED groups which are simultaneously turned on or off, and thus a signal having a frequency of general commercial power can be used as the drive signal, thereby eliminating the necessity of a circuit for converting the frequency and allowing lower costs.

In addition, since the above-described setting method allows a drive time to be set for each of the LED drivers 130(1) to 130(4), it is possible perform optimal settings of the delay time based on a distance between an LED driver and an LED driver positioned at the subsequent stage, thereby increasing convenience. For example, it is possible to set a delay time suitable for a distance between the LED driver 130(1) and the LED driver 130(2). In addition, since an arbitrary delay time can also be set, it is also possible to set a proper delay time according to the number of LED drivers 130.

The backlight apparatus 4 and the display apparatus 1 according to the present invention have hereinbefore been described, but the present invention is not limited to this embodiment. Those skilled in the art will readily appreciate that various modifications may be made in the embodiment, and other embodiments may be made by arbitrarily combining some of the structural elements of different exemplary embodiments without materially departing from the principles and spirit of the inventive concept, the scope of which is defined in the appended Claims and their equivalents.

### INDUSTRIAL APPLICABILITY

The present invention is applicable to backlight apparatuses and display apparatuses, and in particular, to televisions and the like which are capable of displaying an image by receiving a video signal from a broadcast station.

1. A backlight apparatus comprising:
a plurality of backlight groups arranged in a sub scanning direction of a liquid crystal display (LCD) screen, each of the backlight groups including a plurality of backlights arranged in a main scanning direction of the LCD screen, each of the backlights emitting light toward a back surface of the LCD screen;
a plurality of backlight drivers each connected to a corresponding one of the backlight groups for driving the corresponding backlight group; and
a signal outputting unit which is connected to the backlight driver connected to one of the backlight group positioned uppermost and the backlight group positioned lowermost in the sub scanning direction, among the plurality of backlight groups, and is configured to output a drive signal for driving the backlight driver for a set period which is a previously set period,
wherein the plurality of backlight drivers are connected in cascade arrangement, and when the drive signal is provided to the backlight driver corresponding to the one of the backlight group positioned uppermost and the backlight group positioned lowermost in the sub scanning direction, each of the backlight drivers delays the drive signal by a predetermined period and outputs the delayed drive signal in order of the arrangement of the backlight drivers.

2. The backlight apparatus according to claim 1,
wherein each of the backlight drivers changes a phase of the drive signal by outputting the drive signal with a delay.

3. The backlight apparatus according to claim 1,
wherein each of the backlight drivers:
drives the corresponding backlight group in response to an application of a divided voltage obtained from voltage-dividing resistances; and
delays the drive signal to satisfy
T1/T2=R11/R12,
where T1 denotes a delay time of the drive signal, T2 denotes a time period obtained by subtracting the delay time from a period of one cycle of the drive signal, and R11 and R12 denote the voltage-dividing resistances for a corresponding one of the backlight drivers.

4. The backlight apparatus according to claim 1,
wherein each of the backlight drivers:
drives the corresponding backlight group in response to an application of a divided voltage obtained from voltage-dividing resistances;
includes a counter for counting a period of one cycle of the provided drive signal, and a voltage application unit configured to apply a voltage to the voltage-dividing resistances; and
outputs the drive signal with a delay to satisfy
T1=C(Tp)×(V11/V1),
where T1 denotes a delay time of the drive signal, C(Tp) denotes the period of one cycle of the drive signal, V11 denotes the divided voltage divided by the voltage-dividing resistances, and V1 denotes a voltage value of the voltage application unit.

5. The backlight apparatus according to claim 1,
wherein each of the backlight drivers drives the corresponding backlight group such that an entire light-out state in which all of the backlight groups are turned off appears several times in one frame period in which one frame is displayed on the LCD screen.

6. A display apparatus comprising:
the backlight apparatus according to claim 1; and
a liquid crystal display (LCD) screen which receives an image signal representing an image and displays the image, the LCD screen having a back surface to which light is emitted by the backlight apparatus.
